(19) United States
(12) Patent Application Publication
(10) Pub. No.: US 2013/0036051 A1
(43) Pub. Date: Feb. 7, 2013

(54) NON-NEAR FIELD COMMUNICATION POINT OF SALE EXPERIENCE

(71) Applicants: Joseph A. Giordano, Waxhaw, NC (US); Yvette Bohanan, Charlotte, NC (US)

(72) Inventors: Joseph A. Giordano, Waxhaw, NC (US); Yvette Bohanan, Charlotte, NC (US)

(73) Assignee: BANK OF AMERICA CORPORATION, Charlotte, NC (US)

(21) Appl. No.: 13/342,085

(22) Filed: Jan. 1, 2012

Related U.S. Application Data
(60) Provisional application No. 61/514,392, filed on Aug. 2, 2011.

(51) Int. Cl. G06Q 20/40

(52) U.S. Cl. 705/44

(57) ABSTRACT

System, method, and computer program product are provided for a user to provide payment for a transaction via non-near field communications at the point-of-sale. Once a user enters a merchant, the user may purchase products from the merchant through a P2P mobile payment. The user may identify himself/herself on a mobile phone and access the P2P mobile payment system. The user then selects the merchant that he/she is purchasing from and the financial institution providing the user with a payment PIN. The PIN is a randomly generated numbers or letters set that the user inputs at the point-of-sale to provide payment for a transaction at the merchant. This invention allows a user to receive and provide payments for any type of transaction utilizing the security, accuracy, and convenience without having to disclose personal data such as an account number, routing number, or the like.

### CLAIM OF PRIORITY UNDER 35 U.S.C. §119

This Non-provisional Patent Application claims priority to Provisional Patent Application Ser. No. 61/514,392 titled “Non-Near Field Communication Point of Sale Experience” filed Aug. 2, 2011, assigned to the assignee hereof and hereby expressly incorporated by reference herein.

### BACKGROUND

With the wide adoption of credits cards, debit cards, electronic payment devices, online shopping systems, and online banking systems, very few people today carry cash or write many checks. However, people still need to carry around these payment devices for purchasing products or making a payment. In fact, people typically carry several credit cards, debit cards, and the like every time they go shopping or out of the house. Carrying and selecting the proper payment device upon making a transaction request may prove to be cumbersome for many people.

Transactions can also be processed using electronic banking systems, but these systems traditionally require both Internet access and that the sender know account information for the receiver in order to instruct the bank to transfer money to the proper account. Most people do not know the account numbers of their friends or business entities with whom they transact, nor do most people want to widely publicize their account numbers for security reasons.

Therefore a need exists for an improved user-friendly systems and methods for transferring money between two people and/or other entities, especially if such systems can transfer money directly to and/or from financial institution accounts, such as demand deposit accounts (e.g., checking accounts), savings accounts, and/or credit accounts.

### BRIEF SUMMARY

Embodiments of the present invention address these and/or other needs by providing an innovative person-to-person (P2P) payment system utilizing non-near communication via a point-of-sale (POS) terminal. Advantageously, embodiments of the invention do not necessarily require users to share confidential account information with others in order to send and receive payments. In fact, embodiments of the invention do not require that the payment sender know any information about the financial accounts of the intended payment receiver. Furthermore, embodiments of the invention to not require a user to provide a credit card, debit card, cash, etc. at a merchant POS. In this way, embodiments of the invention enable users to make payments to merchants without exposing any personal information to the merchant or surrounding individuals.

Furthermore, embodiments of the present invention provide a P2P mobile payment system that utilizes the network and functionality of merchant host systems to process, send, and receive P2P mobile payments. Embodiments of the invention also create a “viral” account opening and payment system registration process whereby one person's use of the system encourages others to use the system.

More specifically, embodiments of the invention allow an individual to transfer funds to a merchant or other individual via a non-near field communication. The merchant may have a Wi-Fi connection, communication device, or other recognition device that the user mobile device recognizes as an acceptable merchant host system, such that P2P mobile payments may be made to the merchant. The assignee of the present application describes some embodiments of such an invention in U.S. Provisional Patent Application No. 60/991,172, filed on Nov. 29, 2007, and co-pending U.S. patent application Ser. No. 12/038,177, filed on Feb. 27, 2008, as well as in U.S. patent application Ser. Nos. 12/881,071, 12/881,073, 12/881,074, and 12/881,080 continuing therefrom. Embodiments of the present invention include and build off of those earlier embodiments to provide an improved P2P payment system and a more user-friendly, secure, and convenient user interface and method.

Furthermore, embodiments of the invention include and build off of the following applications of the assignee of the present application: U.S. Provisional Patent Application No. 61/410,085, filed on Nov. 4, 2010; U.S. Provisional Patent Application No. 61/410,087, filed on Nov. 4, 2010; U.S. Design Patent Application No. 29/378,420, filed on Nov. 4, 2010; and U.S. Design Patent Application No. 29/378,418, filed on Nov. 4, 2010, and as such, herein incorporate these applications by reference.

As described in greater detail below, an interface can be accessed from a user's mobile device to initiate a payment to a merchant via the P2P mobile payment system. In some embodiments of the invention, the interface may be displayed on the user's mobile device when the user enters a merchant with an acceptable merchant host system. In this way, the user's mobile device may recognize the ability for the user to provide payment to the merchant through the mobile payment program based on recognition of an acceptable merchant host system. In some embodiments, the interface allows a user to select an account to direct the payment from. The user may then be given a random generated payment personal identification number (PIN). The payment PIN may then be entered by the user into the merchant's POS device to create a payment request to the merchant. The financial institution system then accesses the data repository to determine whether the merchant is registered, the payment PIN matches the merchant, and determine a financial institution account associated with the merchant. If the merchant is registered, the financial institution system sends a payment notification to the merchant account and initiates the funds transfer.

The merchant may not be registered. If this is the case, the user's mobile device will not recognize an acceptable merchant host system, thereby not providing an interface for the user to utilize the P2P mobile payment system.

Embodiments of the invention relate to systems, methods, and computer program products for receiving an indication that a user wants to make a payment to the merchant via non-near field communications; providing the user with accounts associated with the user that the user may select from to make the payment to the merchant, wherein the accounts are associated with payment accounts that the merchant accepts for payment of a transaction; providing the user a randomly generated identification number associated with the account selected, wherein the user provides the randomly generated identification number to the merchant as payment; and transferring a payment from an account associated with the user to an account associated with the payment receiver.

In some embodiments a determination is made that the user is an entity associated with the financial institution. Further, a determination is made that the merchant is an acceptable merchant for allowing a payment via the randomly generated identification number.

In some embodiments, determining that the merchant is an acceptable merchant for allowing a payment via the randomly generated identification number further comprises determining a location of the user within the acceptable merchant. Determining the location of the user within the acceptable merchant is further established through non-near field communications.

In some embodiments, transferring of the payment from an account associated with the user to an account associated with the merchant is based at least in part on the merchant responding to a payment notification indicating authorization to receive payment.

In some embodiments, the randomly generated identification number associated with the account selected is unique, such that the randomly generated identification number corresponds to the account selected and is acceptable for payment for a limited amount of time.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a high level process flow illustrating the P2P mobile payment process, in accordance with embodiments of the invention;

FIG. 2 is a combination flowchart and block diagram of a system and method for making P2P mobile payments in accordance with example embodiment of the invention;

FIG. 3 is a block diagram illustrating the various ways through which a customer may make a P2P mobile payments, in accordance with various embodiments of the invention;

FIG. 4 provides a block diagram illustrating a P2P mobile payment system and environment in accordance with an embodiment of the invention;

FIG. 5 provides a block diagram illustrating the mobile device of FIG. 4, in accordance with an embodiment of the invention;

FIG. 6 provides a block diagram illustrating the merchant host system of FIG. 4, in accordance with an embodiment of the invention;

FIG. 7 provides a block diagram illustrating the financial institution system of FIG. 4, in accordance with an embodiment of the invention;

FIG. 8 provides a block diagram illustrating the alias data repository of FIG. 4, in accordance with an embodiment of the invention;

FIGS. 9A-9C provide flow charts illustrating a process for sending P2P mobile payment to a merchant, in accordance with embodiments of the invention;

FIG. 10 provides an illustration of a payment interface, in accordance with example embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like. Furthermore, embodiments of the present invention use the term “user” or “customer.” It will be appreciated by someone with ordinary skill in the art that the user or customer may be a customer of the financial institution providing the P2P mobile payment system, not a customer of the financial institution providing the P2P system, or any combination thereof.

Embodiments of the present invention provide a system and method for utilizing the network and functionality of merchant host systems to send and, in some embodiments, process, P2P mobile payments. Embodiments of the invention allow users to make payments directly from their accounts, whether their accounts be checking, savings, line of credit, credit card, stock, and/or other accounts, to a merchant without having to use a different payment device for each account. In some embodiments, the user and/or merchant may be customers of the financial institution providing the P2P mobile payment system. In some embodiments, the user and/or merchant may not be customers of the financial institution providing the P2P mobile system. The P2P system further allows transfer of funds from a user to a merchant without sharing any confidential account information and without knowing account information for the intended merchant.

It should be noted that some embodiments of the invention allow a customer to make payments to and/or receive payments from a merchant in the same way that a customer can make payments to and/or receive payments from another person. As such, as used herein, the phrase person-to-person (P2P) is intended to include person-to-merchant (P2M), merchant-to-merchant (M2M), and merchant-to-person (M2P) unless specifically stated otherwise. Furthermore, the term “merchant” as used herein, may include, but is not limited to retailers, manufacturers, markets, online retailers, service providers, vendors, or any other provider of goods and/or services in which a user may make a payment to receive.

Moreover, embodiments of the present invention permit a user to send money from the user's financial institution account directly to the merchant's financial institution account by providing an appropriate payment PIN, or alias, at the merchants POS, such that the merchant's account information may be determined based on the POS device at the merchant and the payment PIN entered. In this way, the payments may be directed by accounts or cross accounts to the merchant or person receiving the transfer. This allows for greater security as no party apart from the user, the merchant, and the financial institution is ever a part of the transfer.

It should be appreciated that at least some embodiments of the invention provide a more convenient, user friendly, and secure P2P mobile payment system because it is provided by the user's financial institution, through a financial institution mobile payment client application on the user's mobile device. In at least some embodiments, the user may not need to share personal or confidential information, such as account information, with people or businesses outside of the user's financial institution. The user can feel more secure having P2P payment services handled by their financial institution and having the convenience of being able to directly send money from and/or receive money into the user's one or more financial institution accounts in this way.

In some embodiments, the payment may refer to an event and/or action or group of actions facilitated or performed by a user, typically at a merchant device. Such a device may be referred to herein as a “point-of-sale device” (POS device). A “point-of-sale” could refer to any location, virtual location or otherwise proximate occurrence of a transaction. A “point-of-sale device” may refer to any device used to perform a transaction, either from the user's perspective, the merchant's perspective or both. In some embodiments, the POS device may refers only to a user's device, in other embodiments it refers only to a merchant device, and in yet other embodiments, it refers to both a user device and a merchant device interacting to perform a transaction. For example, in one embodiment, the POS device refers to the merchant's point-of-sale terminal configured to accept non-near field communicates. In other embodiments, the POS device may be a mobile addition, a stationary POS device, a wireless transaction device, a user's device, or the like. In yet other embodiments, a network, such as a local Wi-Fi network may be the POS device, such that the user is provided a mean of provided mobile P2P payments via the Wi-Fi network. In this way, a user, using a mobile device or the like may provide a merchant, without a traditional POS kiosk, etc. payment through the use of a network.

In some embodiments, a POS device is or includes an interactive computer terminal that is configured to initiate, perform, complete, and/or facilitate one or more transactions. A POS device could be or include any device that a user may use to perform a transaction with an entity, such as, but not limited to, an ATM, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo WHO, PlayStation Portable®, etc.), and/or various combinations of the foregoing.

In some embodiments, a POS device is operated in a public place (e.g., on a street corner, at the doorstep of a private residence, in an open market, at a public rest stop, etc.). In other embodiments, the POS device is additionally or alternatively operated in a place of business (e.g., in a retail store, post office, banking center, grocery store, factory floor, etc.). In accordance with some embodiments, the point-of-sale system is not owned by the user of the point-of-sale system. Rather, in some embodiments, the POS device is owned by a mobile business operator or a POS operator (e.g., merchant, vendor, salesperson, etc.). In yet other embodiments, the POS device is owned by the financial institution offering the POS device providing functionality in accordance with embodiments of the invention described herein.

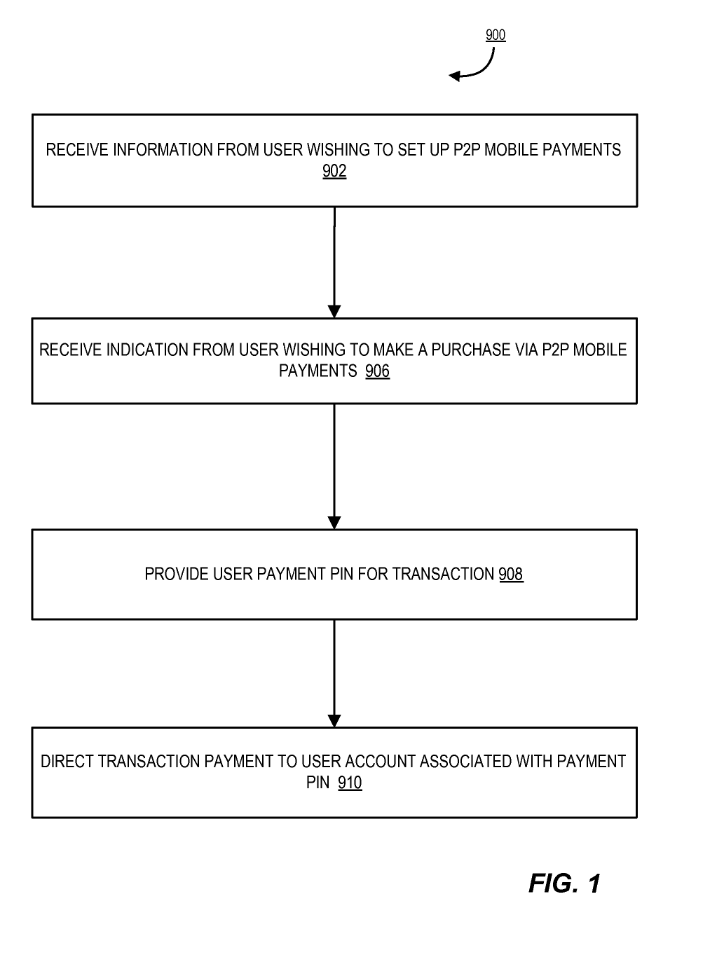

FIG. 1 illustrates a high level process flow of the P2P mobile payment process 900, in accordance with one embodiment of the present invention. First, the system receives information from a user within to set up a P2P mobile payments in block 902. The financial institution may solicit the user to enroll in the program or the user may request enrollment from the financial institution. The user may receive a mobile payment client application for his/her mobile device, such that he/she may be able to use the P2P mobile payments system when at a merchant. In some embodiments, the user is a customer of the financial institution providing the P2P mobile payment system. In yet other embodiments, the user may not be a customer of the financial institution providing the P2P mobile payment system. Once the user has enrolled in the P2P mobile payment system, the user may provide account information and the like, such that the user may use that account for a transaction at a merchant. Next at block 906 the system receives an indication from a user wishing to make a purchase via the P2P mobile payments. In some embodiments, the indication may be received after the user is within the area of an acceptable merchant host system that is enabled to accept payments via the P2P mobile payments program. In other embodiments, the user does not have to be within an acceptable merchant host area. The user may then select a payment account to use for the transaction. At this point, the system sends the user a payment PIN for the transaction in block 908. The payment PIN may then be inputted by the user on the merchant POS device to begin processing the transaction for the account associated with the payment PIN 910.

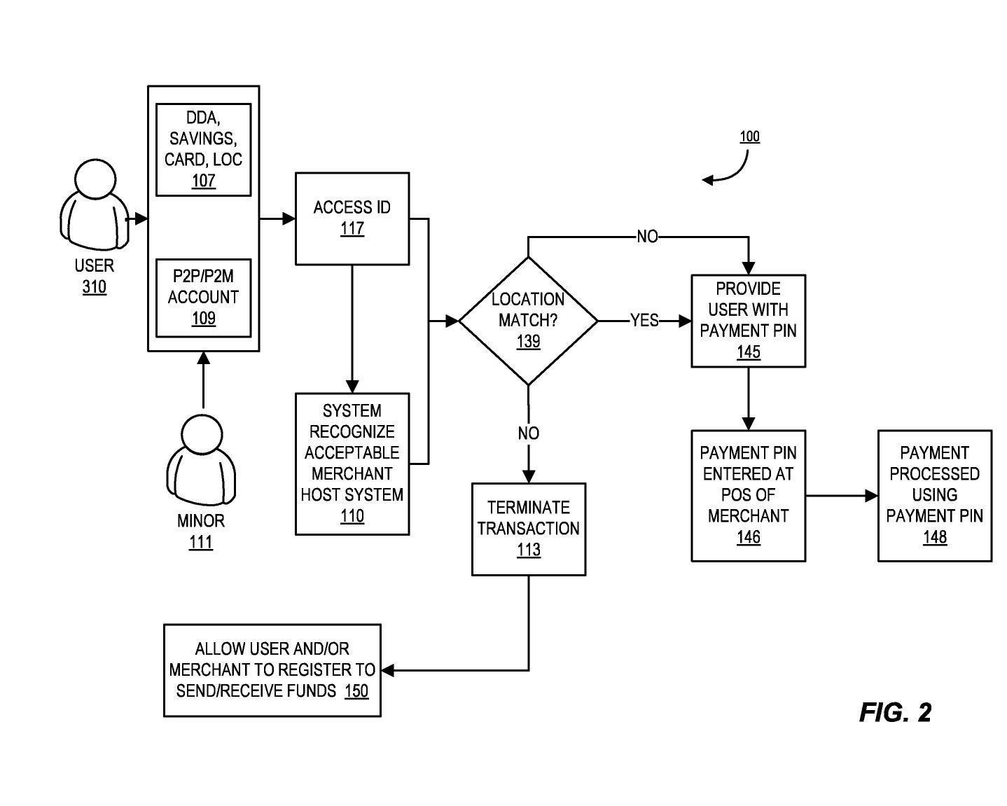

FIG. 2 is a combination block diagram and flowchart providing an overview of a system and method 100 for making P2P mobile payments, in accordance with one or more embodiments of the invention. A user 310 with an eligible account 107, e.g., checking (demand deposit account or “DDA”), savings, money market, line of credit, credit card, etc., of any financial entity is be able to register and make use of this service. Hereinafter, a user 310 may include customers of the financial institution providing the P2P mobile payment system or individuals whom are not customers of the financial institution providing the P2P mobile system. During the registration process, the user 310 is able to set up an access ID 117 that maps back to the user's accounts and provides access to the system for the user 310. The access ID 117 may be any unique identifier other than the user's financial institution account number and may include a name, address, email address, URL address, PIN number, picture, graphical art, trade name, trademark, logo, brand, or any other textual, graphical, or visual indicator. In this way, the access ID 117 may be unique to the user 310 and provide the user 310 with access to the system. The embodiments of the invention described herein in the other figures generally permit the users 310 to use either a mobile telephone number, PIN number, social network ID, or an email address as the account access ID 117, but it will be appreciated that, in view of this disclosure, other embodiments of the invention may allow use of other access ID types.

The information provided by the user 310 during registration of an access ID 117 may be verified to confirm that the user 310 does have access to the financial institution accounts. For example verification of a PIN number or the like. In yet another example, the financial institution (or other entity that maintains a database of access IDs and associates them with financial institution accounts) may send a communication to the user 310 using the access ID and require the user 310 confirm access by responding to the notice in some way. Once the access ID is verified, then the access ID is linked to one or more of the customer's financial institution accounts in a data repository maintained by the financial institution or some other entity that provides a registry service to the financial institution.

The user 310 can use embodiments of the invention to make payments to merchants. In some embodiments, payments to merchants may occur by merchant notification of user 310 within the merchant location, if the merchant is an acceptable merchant host system 110. In other embodiments, payments to merchants may occur by the user device notification of the merchant host system that the user 310 is at an acceptable merchant host system 110. In some embodiments of the invention, the user 310 is able to set preferences for accounts to be used for outgoing payments, and default account(s) for incoming payments. In some embodiments of the invention, the financial institution places limits (e.g., maximums and/or minimums) on how much money can be sent or received over a specified period of time using P2P mobile payment, and such limits may be based on the user 310, the merchant, whether the user 310 is a customer of the financial institution or a partner financial institution, account history, credit ratings, customer status, and/or any other relevant information. In some embodiments, the user 310 can also establish limits on P2P payments. For example, a user 310 may want to set a maximum of $1000 for P2P payments. In other embodiments, if the user 310 is a minor 111, the minor 111 may have limited access to the P2P accounts. For example, a minor 111 may be limited to the amount of funds available for a P2P mobile payment.

In some embodiments of the invention, the user 310 may also have an option of opening a new P2P account 109 with the financial institution that the user 310 may use exclusively for making P2P mobile payments. This financial entity P2P account 109 may be like any other account hosted at the financial entity and so money may be moved instantly into this account 109 through the regular process for moving money between a user's accounts. This account 109 may be a type of checking account except that it may come with certain limitations, e.g., no checks, maximum balance limits, number of daily transactions or the like, and may be opened by users 310 by providing much less information as compared to a regular checking account. The financial entity may, at a minimum, require users to provide certain information, such as name, address, date of birth, and social security number, in order to comply with Anti-Money Laundering (AML) regulations. Users 310 may also have an option to set up P2P accounts 109 (i.e., sub-accounts) for minors 111, other dependents, or related entities. Users 310 are able to access these accounts just like any of their other accounts. In addition, users 310 are able to set up an access ID for the minor 111 that the minor 111 may use for P2P payments and have access only to the specific minor P2P account 109 set up for them. These P2P-specific accounts and sub-accounts are described in more detail in U.S. patent application Ser. No. 12/038,177 filed on Feb. 27, 2008 and entitled “Sub-Account Mechanism,” which application was assigned to, or subject to an obligation to assign to, the same assignee of the present application at the time of filing of the present application and at the time of conception of the inventions described herein.

Referring again to FIG. 2, users 310 are able to make payments to merchants through any of a number of different methods. In one such method the user 310 may enter an acceptable merchant location. An acceptable merchant is a merchant that has the ability to accept payment for transactions via the P2P mobile payment process. In this way, the merchant may have provided account information and the like to the financial institution, such that the financial institution has access to the account, etc. to use in the P2P payment system. Therefore, once the user 310 enters an acceptable merchant location, the user 310 may receive an indication that they are able to pay via the P2P mobile payment program. If the merchant has a pre-established a relationship with the financial institution and the user 310 provided P2P payment to the entity an error will not occur if the user 310 attempts to provide payment to the merchant via the P2P payment system because the entity has pre-established a relationship with the financial institution and the P2P payment system. In this way, the user 101 may be able to sent payments to the entity directly without any delay. In this case a location match 139 is made between an accepted merchant and a user 310 of the P2P payment system. In some embodiments, the user 310 may use the P2P payment system without being within an acceptable merchant location.

If there is no match in block 139, then a message may be sent to the user 310 that he/she is not near an acceptable merchant host and any subsequent attempted transactions through the P2P payment system at that location may be terminated, as illustrated in block 113. However, in some embodiments, the user 310 may be able to make a purchase using the system without the merchant host being acceptable. In this way, the user 310 may use the system to purchase products at any merchant. As represented by block 150, if the merchant or user 310 is an existing financial institution account holder a message is sent to the merchant or user 310 such that they may be allowed to sign into the P2P payment system and register an access ID for the P2P system as illustrated by block 150, and then receive/send funds via the P2P mobile payment process. If the merchant is not a financial institution user with an account eligible for receiving funds, then the merchant may be given the option to sign up for a financial institution account at the financial institution.

In accordance with embodiments of the invention, payments may be initiated by a user 310 providing an access ID 117. In general, as described in greater detail below, the user 310 initiates a P2P mobile payment by imputing an access ID 117 on his/her mobile. In some embodiments, the user 310 may be within an acceptable merchant host location. The location may be determined by merchant Wi-Fi, GPS data, other tracking data, the user's 310 mobile device, and the like. In this way a location match 139 may be made between a user 310 and a merchant that is able to provide payment options through the P2P payment system. This communication provides an additional, yet optional, security level, only allowing P2P mobile payments to occur within a location of an acceptable merchant. In some embodiments, the system may not require the user 310 to be within an acceptable merchant host area. In this way, the user 310 may use the P2P payment system without the extra security function of being located in the merchant host location. The financial institution then accesses a data repository, to determine if the entered access ID 117 has been registered by the user 310 and is, thereby, associated with a particular financial institution account. If the access ID 117 does have a match to another user or financial institution account of another user, then the payment may be initiated, as described in greater detail below. If there is no match, then either an error message is generated or, if possible, the access ID 117 may be used to contact the user 310 via the user's mobile device or access the merchant to allow the merchant to register to receive P2P mobile payments.

In some embodiments of the invention, and access ID 117 may be associated with a user 310 and not an account associated with the user 310. In some embodiments of the invention, an access ID 117 may be associated with multiple financial institution accounts of the user 310. In some such embodiments, the user 310 may be able to establish a default account when registering the access ID 117 or afterwards. Consequently, if a merchant does have a default account for incoming payments, then the funds may be transferred instantly to that account(s). If the merchant has not set up a default account, but the merchant does have multiple accounts associated with them, then the funds may be moved to a master settlement account and the merchant may see the payment as an incoming payment within online banking The merchant may then be able to use the online banking application to move the funds instantly to any of the merchant's others accounts. In other embodiments, however, each merchant is associated only with one financial institution account and, therefore, the payment is deposited directly into the one financial institution account associated with the merchant.

Referring once more to FIG. 2, the system provides the user 310 with a payment PIN in block 145. In some embodiments, a payment PIN is provided to the user 310 upon a location match 139 between the user 310 and the merchant location the user 310 is in. In some embodiments, the user 310 may be provided a payment PIN from the system without a location match between the user 310 and the merchant host location. In some embodiments, the payment PIN may be a randomly generated PIN number that acts as an account number for both the merchant and the financial institution processing the transaction. In this way, the payment PIN provides the user 310 with a one time number that is recognized to be associated with the user's 310 account that he/she selected for payment. In some embodiments, the payment PIN may be static, such that the payment PIN may represent the same account number or same individual. In this way, the user 310 may have a static payment PIN that is associated with a single, default account or a static payment PIN that is associated with an account the user 310 selects to use for that P2P payment. The user 310 may input the payment PIN at the POS device of the merchant 146, such that the merchant may request a transaction to be processed with a financial institution. The payment PIN may be recognized by both the merchant and the financial institution as being acceptable for the transaction. The transaction of the user 310 at the merchant may then be processed using the payment PIN as a substitute for any account numbers, routing numbers, or account identifies, as illustrated in block 148. In some embodiments, the transaction is processed by the financial institution providing the P2P mobile payment system. In other embodiments, the transaction is processed by a financial institution not providing the P2P mobile payment system. In yet other embodiments, the transaction is processed by the merchant.

In some embodiments, the merchant may be allowed to reject or re-route the payment. In some embodiments of the invention, the user 310 is permitted to include a note to the merchant along with the payment, such as a note explaining to the receiver what the purpose of payment. In some embodiments, the merchant is not a user of the financial institution.

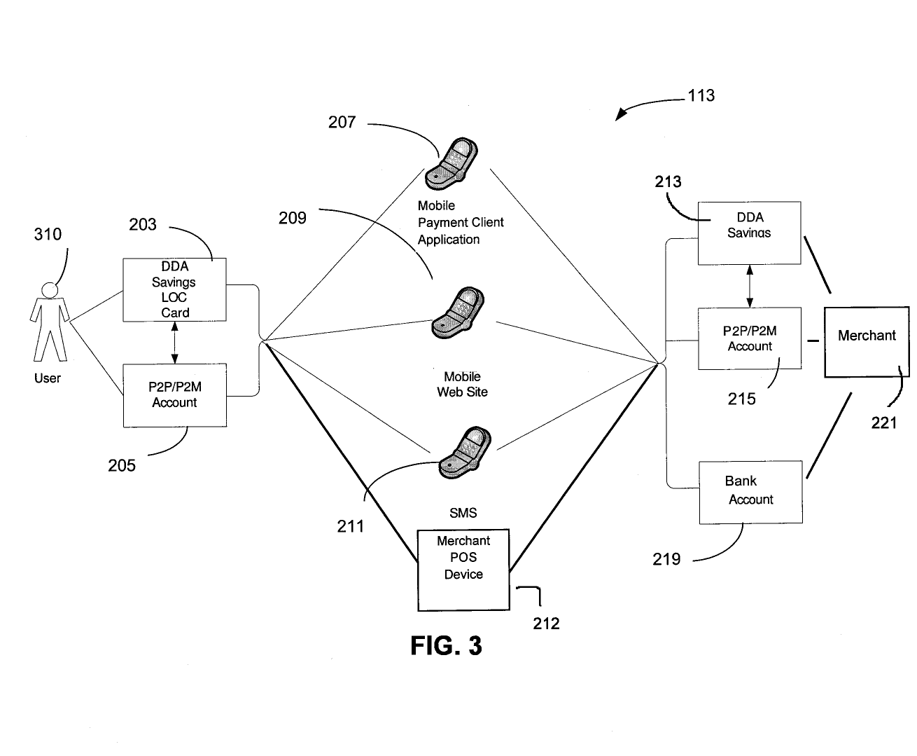

FIG. 3 is a block diagram illustrating the various ways through which a user 310 may make P2P mobile payments 113, in accordance with various embodiments of the invention. As illustrated, in some embodiments of the invention, a user 310 who is signed up for the P2P mobile payment service has the option to initiate P2P payments from a DDA, savings, line of credit, and/or credit card account 203 of the financial entity (and/or from a P2P-specific account 205 with the financial entity) through the merchant's POS device 212, financial entity's mobile banking website 209 or a mobile payment client application 207 by providing any of the above-described access ID information, along with a payment amount. Once an access ID is provided, the system may ensure the location of the user 310 matches that of an acceptable merchant host system, at which point the system may provide a user 310 mobile device with a random payment PIN associated with an account of the user 310. The randomly generated payment PIN is good for that transaction, at that time, at that merchant, and that merchant POS device 212. Once a given amount of time expires or the user 310 is located at a different merchant, the user 310 may request a different randomly generated payment PIN. The second randomly generated payment PIN may be associated with the same account as the first randomly generated payment PIN. In this way, the user's 310 account information is secure. In some embodiments the payment PIN may be static. The static payment PIN may be associated with the user 310, the user's default account, or the user 310 may select which account the static payment PIN may be associated with for that specific P2P payment.

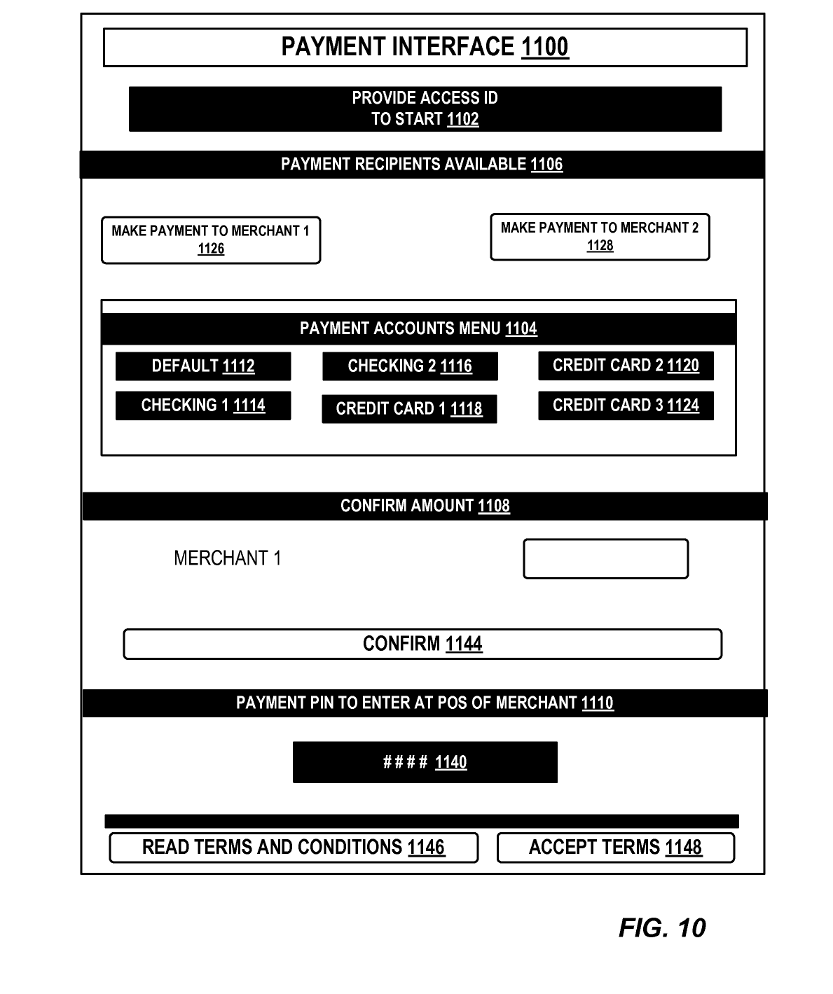

In some embodiments, users 310 may initiate payments by accessing a payment interface by providing an access ID, such as described in further detail below with respect to FIG. 10 via a mobile payment client application 207. In some embodiments of the invention, users 310 can alternatively or additionally initiate payments by sending a text message 211 to the financial entity, the text message indicating that the user 310 is in a location of an accepted merchant host system and user's 310 access ID. In some embodiments, users 310 can alternatively or additionally use the merchants POS device 212 to initiate a payment by inputting an access ID and subsequently providing the POS device 212 a random payment PIN that is provided to the user 310 via the user's 310 mobile device. Whether via a mobile payment client application 207, mobile website 209, short message service 211, or POS device 212, a merchant 221 associated with the financial entity may receive funds at the merchant's financial institution account (e.g., DDA, savings, or credit account 213 or P2P-specific account 215). A merchant 221 not associated with the financial entity may receive funds at the merchant's 221 financial institution account 219 at another partner financial institution if the account is registered and associated with the merchant 221.

It should be appreciated that embodiments of the invention described above permit an entity to send money to another entity even if the sending entity does not know any account information for the recipient entity and only knows a mobile telephone number or email address of the recipient entity. This can also result in better protection of personal account information. It should also be appreciated that some embodiments of the invention create a viral registration and/or account opening system that allows for customers of a financial institution to send payments to anyone outside the financial entity using an access ID. In such embodiments, the non-customers are able to open an access ID by downloading the mobile payment client application and they are allowed to quickly open and/or register an account with the financial institution in order to participate in the P2P mobile payment program.

As described above, FIGS. 1 and 2 provide an overview of the P2P mobile payment system and process of embodiments of the invention. FIGS. 3-10, described below, provide a more detailed description of some systems and methods of implementing embodiments the invention in a merchant POS environment. Specifically, embodiments of the invention described below disclose a user-friendly non-near field POS experience, with an interface and method that may be used by a financial institution to: (1) allow customers to send P2P payments to a merchant they are transacting; (2) allow users to register an access ID and then make payments to a merchant via an P2P mobile payment; and (3) allow customers to easily manage their P2P payments.

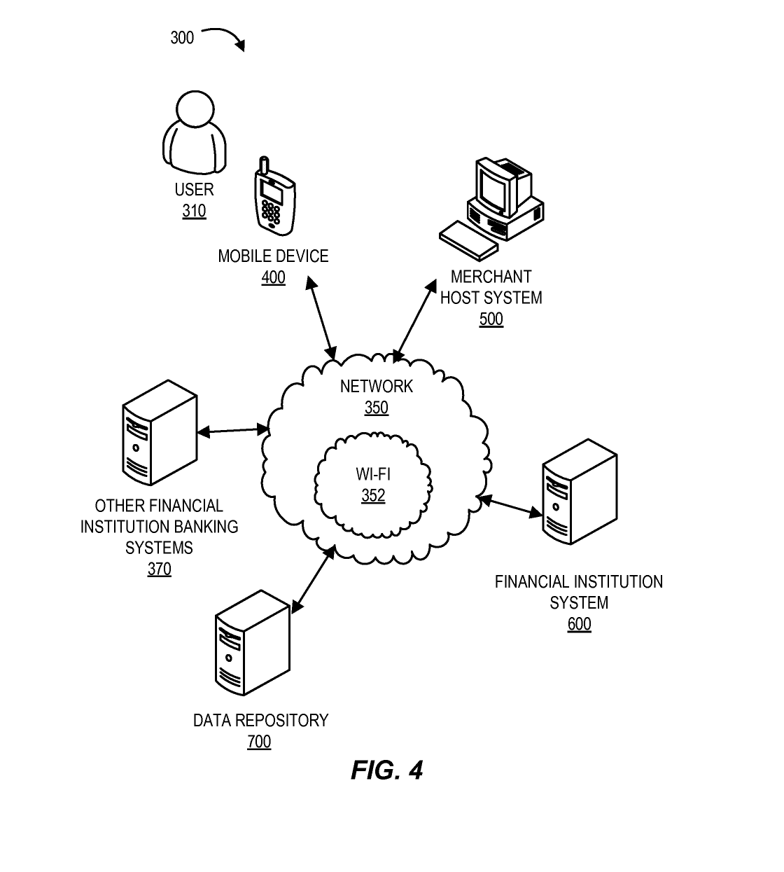

FIG. 4 provides a block diagram illustrating a P2P mobile payment system and environment 300, in accordance with an embodiment of the invention. As illustrated in FIG. 4, the P2P mobile payment environment 300 includes a user 310 that wants to send funds to a merchant for the processing and completion of a transaction. A user 310 of the system may be a person, but may also be a business (e.g., a merchant, retailer, manufacturer, or the like) or any other entity capable of sending or receiving money.

The environment 300 also includes one or more merchant host systems 500. Each merchant host system 500 may be a device that employs a processor and memory and can perform computing functions, such as accessing, retrieving, and sending funds. Furthermore, the merchant host system 500 may have a Wi-Fi 352 or other network associated with the merchant host system 500 that may recognize a user 310 mobile device 400 within the area of the merchant host system 500. In this way, the merchant host system 500 may recognize a user 310 attempting to purchase a product via the P2P mobile payment system. The merchant host system 500 may communicate with the financial institution system 600 and/or the mobile device 400 such that the recognition that a user 310 is within a merchant's location triggers the activation of the user's 310 mobile payment client application. In this way, the user 310 may provide payment to the merchant via the P2P mobile payment system using a payment PIN provided by the financial institution system 600 to the mobile device 400 after recognition form the merchant host system 500 that a user 310 using the P2P mobile payment system is in the merchant's location.

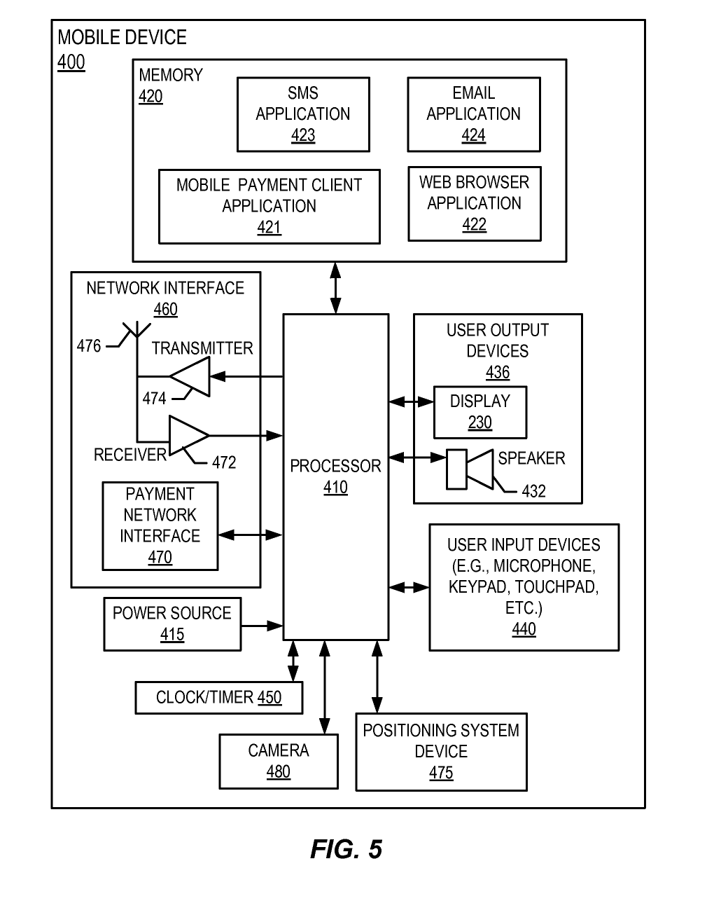

The merchant host system 500 is configured to communicate over a network 350 which includes a Wi-Fi network 352 with a financial institution system 600 and, in some cases, one or more other financial institution banking systems 370. The merchant host system 500, the financial institution system 600, the data repository 700, and any other participating financial institution's banking systems 370 are each described in greater detail below with reference to FIGS. 5-8.

The merchant host system 500 is further configured to receive payment PIN information from a user 310 via the display of the merchant host system 500. The merchant host system 500 may send the payment PIN to a financial institution system 600 to process the user 310 transaction associated with the payment PIN.

The network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet. The network may further include Wi-Fi 352, such that the systems of the network may communicate via a Wi-Fi 352 connection, if the systems are co-localized, such as a merchant host system 500 and a mobile device 400 when the user 310 is within the merchant making a purchase.

Furthermore, in some embodiments, a network, such as Wi-Fi 352 may take the place of a POS device, thus a POS device may not be needed to complete a P2P mobile payment. The use of a wireless connection, such as the use of a Wi-Fi 352 network or the like, may take the place of the POS device as described herein. For example, a P2P mobile payment may be made at a merchant, through communications with the merchant via a network connection. In this way, no device, such as a kiosk, etc. may be required for the P2P mobile payment.

In general, a mobile device 400 is configured to connect with the network 350 to log the user 310 into a financial institution system 600 via the mobile payment client application. The mobile device 400 may be a cellular phone, PDA, smart phone, or the like that is able to download and access client applications or recognize Wi-Fi 352 or other networks 350. Furthermore, the mobile device may have a display that allows the user 310 to access and input data on the payment interface 1100.

The financial institution system 600 provides authentication of the user 310, via an access ID, in order to access the user's account on the financial institution system 600. Once a user 310 enters a merchant and the merchant host system 500 recognizes the user 310. The user may enter an authentication access ID in order to sign into the P2P mobile payment system. In this way, the financial institution system 600 may determine the authentication of the user 310 via the access ID and determine that the user 310 is co-localized to an acceptable merchant host system 500. The financial institution system 600 then provides the user 310 a payment PIN that the user 310 may use to provide the merchant as payment for the transaction. In some embodiments, the payment PIN is randomly generated. In some embodiments, the user 310 may select a static payment PIN associated with each account or a static payment PIN associated with the user 310. The financial institution system 600 provides the user 310 with access to the P2P mobile system via an interface, such as that described below with respect to FIG. 10. In this way, the financial institution system 600 receives the input from the user 310 to initiate authentication to the P2P mobile payment system.

The financial institution system 600 is in network communication with other devices, such as the mobile device 400, an alias data repository 700, a merchant host system 500, and other financial institution banking systems 370.

In some embodiments of the invention, the data repository 700 is configured to be controlled and managed by one or more third-party data providers (not shown in FIG. 3) over the network 350. In other embodiments, the data repository 700 is configured to be controlled and managed over the network 350 by the same entity that maintains the other financial institution banking systems 370. In other embodiments, the alias data repository 700 is configured to be controlled and managed over the network 350 by the financial institution implementing the P2P mobile payment system of the present invention. In still other embodiments, the data repository 700 is a part of the financial institution system 600.

The other financial institution banking systems 370 communicate, over a network 350, with the financial institution system 600 and the other systems. The other financial institution banking systems 370 may provide account data to the financial institution system 600 such that an account of a user 310 or merchant may be with a different financial institution and not necessarily the financial institution providing.

FIG. 5 provides a block diagram illustrating the user mobile device 400 of FIG. 4 in more detail, in accordance with embodiments of the invention. In one embodiment of the invention, the mobile device 400 is a mobile telephone. However, it should be understood, however, that a mobile telephone is merely illustrative of one type of mobile device 400 that may benefit from, employ, or otherwise be involved with embodiments of the present invention and, therefore, should not be taken to limit the scope of embodiments of the present invention. Other types of mobile devices 400 may include portable digital assistants (PDAs), pagers, mobile televisions, gaming devices, laptop computers, cameras, video recorders, audio/video player, radio, GPS devices, or any combination of the aforementioned.

The mobile device 400 generally includes a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 350. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable Wi-Fi network 352. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN) or other communication/data networks.

The network interface 460 may also include a payment network interface 470. The payment network interface 470 may include software, such as encryption software, and hardware, such as a modem, for communicating information to and/or from one or more devices on a network 350. For example, the mobile device 400 may be configured so that it can wirelessly communicating PIN numbers or other authentication information to a terminal of the network 350.

As described above, the mobile device 400 has a user interface that is, like other user interfaces described herein, made up of user output devices 436 and/or user input devices 440. The user output devices 436 include a display 230 (e.g., a liquid crystal display or the like) and a speaker 432 or other audio device, which are operatively coupled to the processor 410. The user input devices 440, which allow the mobile device 400 to receive data from a user may include any of a number of devices allowing the mobile device 400 to receive data from a merchant, such as a keypad, keyboard, touch-screen, touchpad, microphone, mouse, joystick, other pointer device, button, soft key, and/or other input device(s). The user interface may also include a camera 480, such as a digital camera.

The mobile device 400 may also include a positioning system device 475 that is configured to be used by a positioning system to determine a location of the mobile device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 400. In this way, the financial institution system 600 may co-localize the merchant host system 500 with the mobile device 400 of the user 310. In other embodiments, the positioning system device 475 includes a proximity sensor or transmitter, such as an RFID tag, that can sense or be sensed by devices known to be located proximate a merchant or other location to determine that the consumer mobile device 400 is located proximate these known devices.

The mobile device 400 further includes a power source 415, such as a battery, for powering various circuits and other devices that are used to operate the mobile device 400. Embodiments of the mobile device 400 may also include a clock or other timer 450 configured to determine and, in some cases, communicate actual or relative time to the processor 410 or one or more other devices.

The mobile device 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory, or the like.

The memory 420 can store any of a number of applications which comprise computer-executable instructions/code executed by the processor 410 to implement the functions of the mobile device 400 described herein. For example, the memory 420 may include such applications as a conventional web browser application 422 and/or a P2P mobile payment system client application 421. These applications also typically provide a graphical user interface (GUI) on the display 230 that allows the user 310 to communicate with the mobile device 400, the financial institution system 600, and/or other devices or systems. In one embodiment of the invention, when the user 310 decides to enroll in the P2P mobile payment program, the user 310 downloads or otherwise obtains the mobile payment client application from the financial institution system 600 or from a distinct application server. In other embodiments of the invention, the user 310 interacts with the financial institution system 600 via the web browser application 422 in addition to, or instead of, the mobile P2P payment system client application 421. Furthermore the display 230 allows the mobile payment client application 421 to provide the user 310 the payment PIN such that the user 310 may provide it to the POS device at the merchant to provide payment for a transaction.

The memory 420 can also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information, etc.

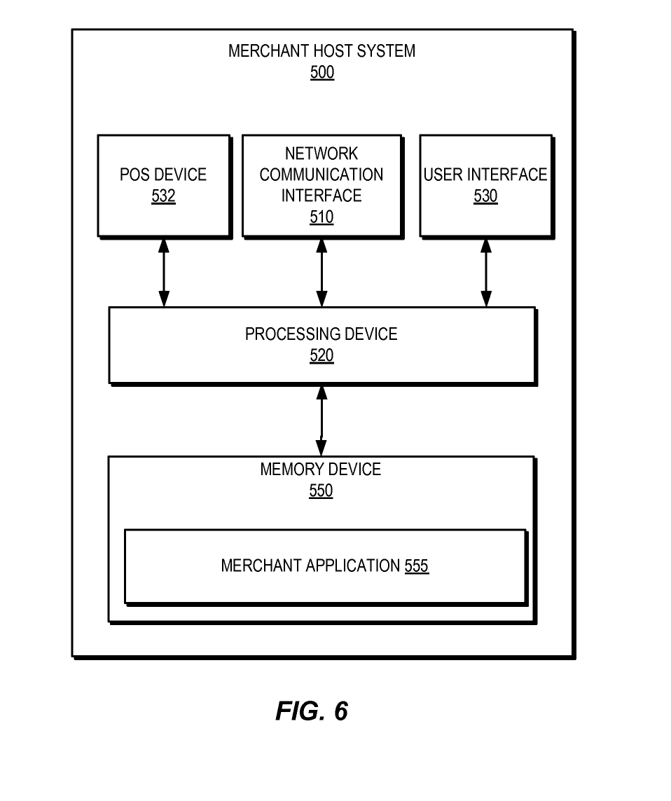

Referring now to FIG. 6, the merchant host system 500 associated with the merchant also includes various features, such as a network communication interface 510, a processing device 520, a user interface 530, a POS device 532, and a memory device 550. The network communication interface 510 includes a device that allows the merchant host system 500 to communicate over the network 350 (shown in FIG. 4). In one embodiment of the invention, a merchant application 555 provides for a user 310 to establish network communication with the financial institution system 600 (shown in FIG. 4) for the purpose of initiating mobile payment and/or registering an account and/or receiving a payment PIN for purchase of a product at a merchant, in accordance with embodiments of the invention. The POS device 532 allows for a user 310 to swipe a payment device such as a credit card, debit card, etc. to pay for a product at a merchant. In other embodiments, the user 310 may use the POS device 532 to input the payment PIN received by the user 310 at the user's mobile device 400.

As used herein, a “processing device,” such as the processing device 520, generally refers to a device or combination of devices having circuitry used for implementing the communication and/or logic functions of a particular system. For example, a processing device 520 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 520 may further include functionality to operate one or more software programs based on computer-executable program code thereof, which may be stored in a memory. As the phrase is used herein, a processing device 520 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” 530 generally includes a plurality of interface devices and/or software that allow a customer to input commands and data to direct the processing device to execute instructions, such as on a POS device 532. For example, the user interface 530 presented in FIG. 6 may include a graphical user interface (GUI) or an interface to input computer-executable instructions that direct the processing device 520 to carry out specific functions. The user interface 530 employs certain input and output devices to input data received from the user 310 or output data to the user 310. These input and output devices may include a display, mouse, keyboard, button, touchpad, touch screen, microphone, speaker, LED, light, joystick, switch, buzzer, bell, and/or other user 310 input/output device for communicating.

As used herein, a “memory device” 550 generally refers to a device or combination of devices that store one or more forms of computer-readable media for storing data and/or computer-executable program code/instructions. Computer-readable media is defined in greater detail below. For example, in one embodiment, the memory device 550 includes any computer memory that provides an actual or virtual space to temporarily or permanently store data and/or commands provided to the processing device 520 when it carries out its functions described herein. The merchant application 555 may communicate with the financial institution system 600 and the data repository 700 to communicate a user 310 inputted payment PIN such that a transaction for payment from the user 310 may be processed.

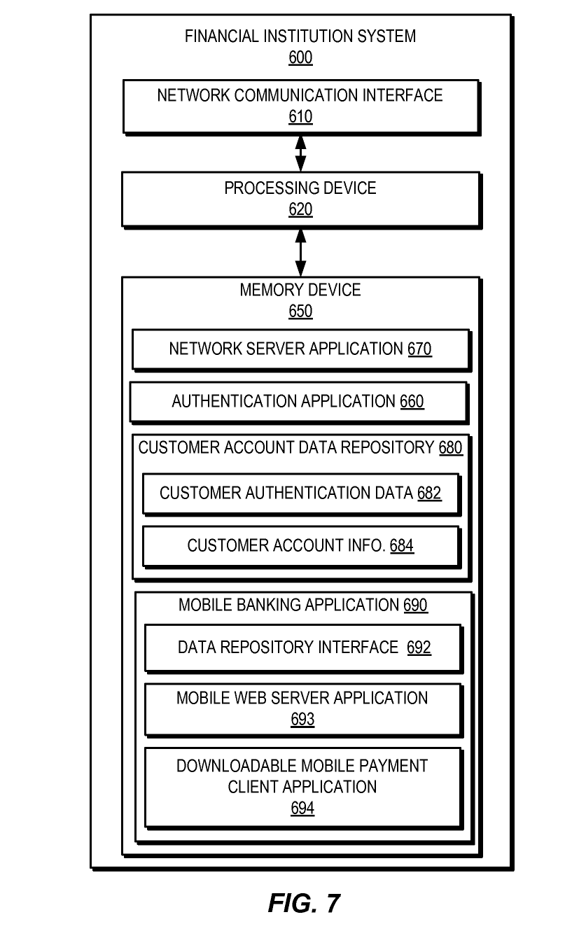

FIG. 7 provides a block diagram illustrating the financial institution system 600 in greater detail, in accordance with an embodiment of the invention. As illustrated in FIG. 7, in one embodiment of the invention, the financial institution system 600 includes a processing device 620 operatively coupled to a network communication interface 610 and a memory device 650. In certain embodiments, the financial institution system 600 is operated by a first entity, such as a financial institution, while in other embodiments, the financial institution system 600 is operated by an entity other than a financial institution.

It should be understood that the memory device 650 may include one or more databases or other data structures/repositories. The memory device 650 also includes computer-executable program code that instructs the processing device 620 to operate the network communication interface 610 to perform certain communication functions of the financial institution system 600 described herein. For example, in one embodiment of the financial institution system 600, the memory device 650 includes, but is not limited to, a network server application 670, an authentication application 660, a customer account data repository 680 which includes customer authentication data 682 and customer account information 684, a mobile banking application 690 which includes a data repository interface 692, a mobile web server application 693, a downloadable mobile P2P payment system client application 694 and other computer-executable instructions or other data. The computer-executable program code of the network server application 670, the authentication application 660, or the mobile banking application 690 may instruct the processing device 620 to perform certain logic, data-processing, and data-storing functions of the financial institution system 600 described herein, as well as communication functions of the financial institution system 600.

In one embodiment, the customer account data repository 680 includes customer authentication data 682 such at access ID information and customer account information 684. The network server application 670, the authentication application 660, and the mobile banking application 690 are configured to implement customer account information 684, the customer authentication data 682, and the data repository interface 692 when authenticating the user 310 to the financial institution system 600.

As used herein, a “communication interface” generally includes a modem, server, transceiver, and/or other device for communicating with other devices on a network, and/or a user interface for communicating with one or more users 310. Referring again to FIG. 7, the network communication interface 610 is a communication interface having one or more communication devices configured to communicate with one or more other devices on the network 350, such as the mobile device 400, the merchant host system 500, the other financial institution banking systems 370, and the data repository 700. The processing device 620 is configured to use the network communication interface 610 to transmit and/or receive data and/or commands to and/or from the other devices connected to the network 350. For example, the financial institution system 600 may receive an indication from the merchant host server 500 that a user 310 is in the merchant's store. Then or concurrently, the financial institution system 600 may receive an indication that the user 310 may wish to make a payment to the merchant via the P2P mobile payment system. The financial institution system 600 may receive an access ID from the user 310 via the user's 310 mobile device 400. The financial institution system 600 may also provide the payment PIN to the user's 310 mobile device 400, so that the user 310 may input the payment PIN into the merchant host system 500. In this way, the user 310 may provide an account from the P2P mobile payment system to purchase products via the P2P mobile payment system.

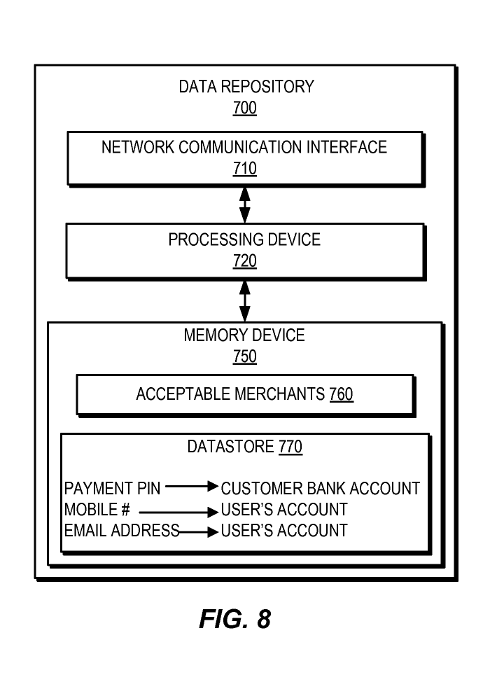

FIG. 8 provides a block diagram illustrating a data repository 700, in accordance with an embodiment of the invention. In one embodiment of the invention, the data repository 700 is operated by a second entity that is a different or separate entity from the first entity (e.g., the financial institution) that, in one embodiment of the invention, implements the financial institution system 600. In one embodiment, the data repository 700 could be part of the financial institution system 600. In another embodiment, the data repository 700 is a distinct entity from the financial institution system 600. As illustrated in FIG. 8, the data repository 700 generally includes, but is not limited to, a network communication interface 710, a processing device 720, and a memory device 750. The processing device 720 is operatively coupled to the network communication interface 710 and the memory device 750. In some embodiments of the invention, the data repository 700, the memory device 750 stores, but is not limited to, a mobile banking system interface 760 and a datastore 770. The datastore 770 stores data regarding the acceptable merchants 760 including, but not limited to, names, locations, account information, and the like for all merchants that are acceptable merchants that participate in the P2P mobile payment system. In one embodiment of the invention, both the acceptable merchants 760 and the datastore 770 may associate with applications having computer-executable program code that instructs the processing device 720 to operate the network communication interface 710 to perform certain communication functions involving the datastore 770 described herein. In one embodiment, the computer-executable program code of an application associated with the datastore 770 may also instruct the processing device 720 to perform certain logic, data processing, and data storing functions of the application associated with the datastore 770 described herein.

The network communication interface 710 is a communication interface having one or more communication devices configured to communicate with one or more other devices on the network 350. The processing device 720 is configured to use the network communication interface 710 to receive information from and/or provide information and commands to a mobile device 400, a merchant host system 500, other financial institution banking systems 370, the financial institution system 600, and/or other devices via the network 350. In some embodiments, the processing device 720 also uses the network communication interface 710 to access other devices on the network 350, such as one or more web servers of one or more third-party data providers. In some embodiments, one or more of the devices described herein may be operated by a second entity so that the third-party controls the various functions involving the data repository 700. For example, in one embodiment of the invention, although the financial institution system 600 is operated by a first entity (e.g., a financial institution), a second entity operates the data repository 700 that stores the randomly generated payment PIN numbers associated with the user's financial institution accounts and other information about users 310.

As described above, the processing device 720 is configured to use the network communication interface 710 to gather data from the various data sources. The processing device 720 stores the data that it receives in the memory device 750. In this regard, in one embodiment of the invention, the memory device 750 includes datastores 770 that include, for example, a payment PIN information for customer financial institution account numbers and routing information.

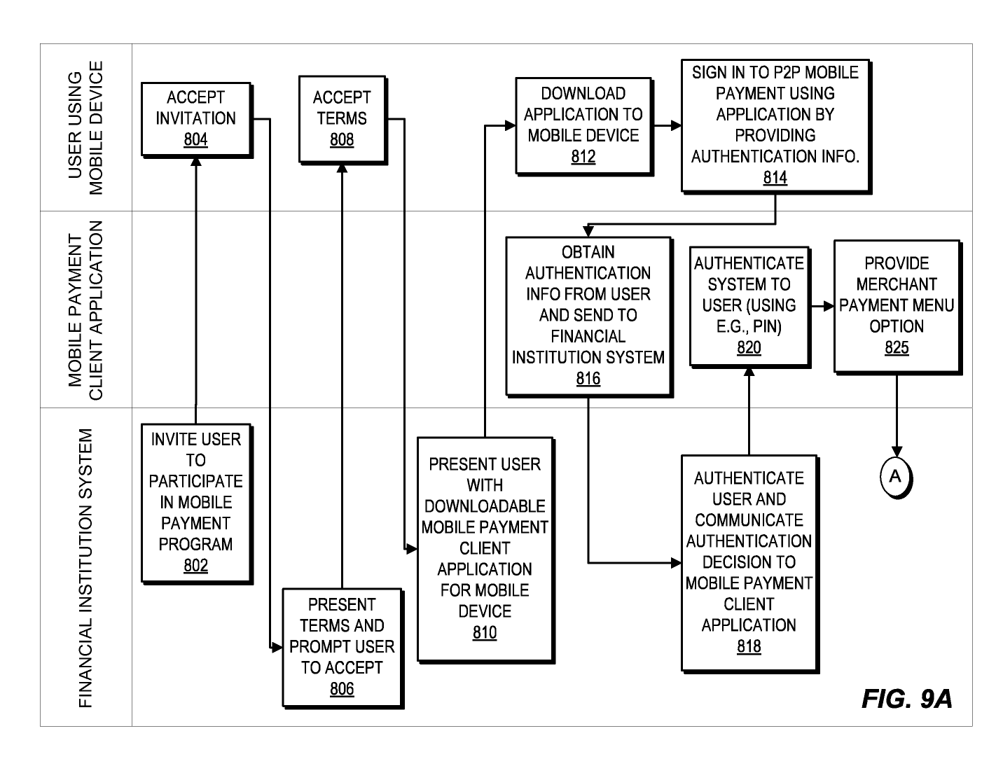

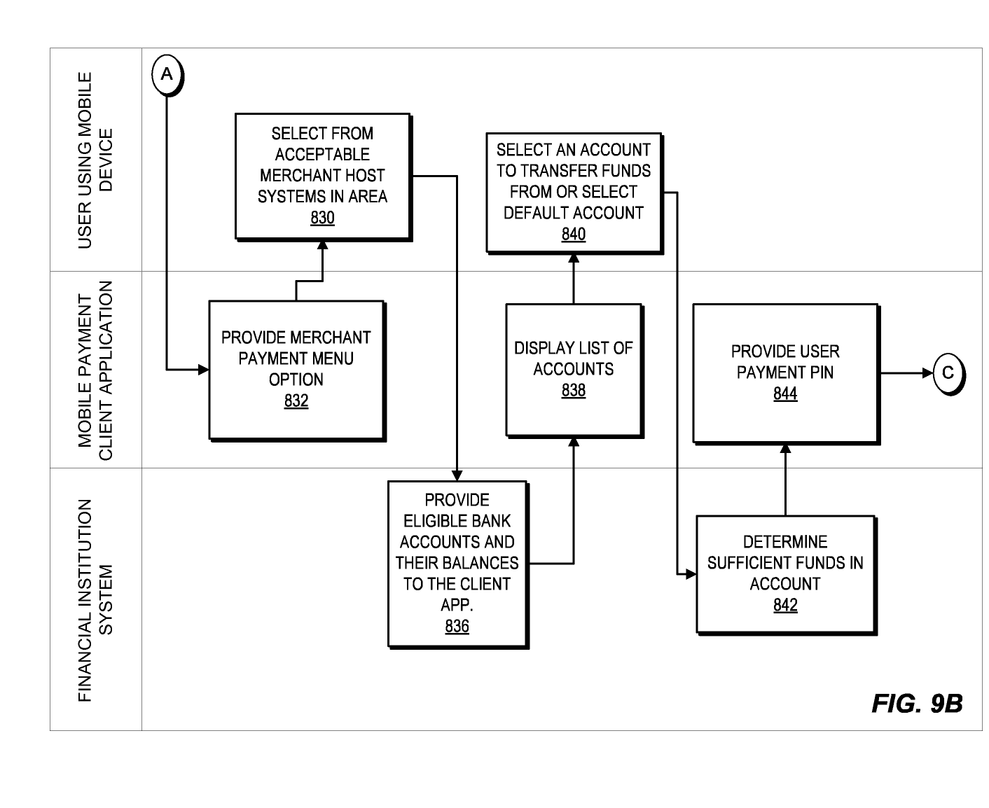

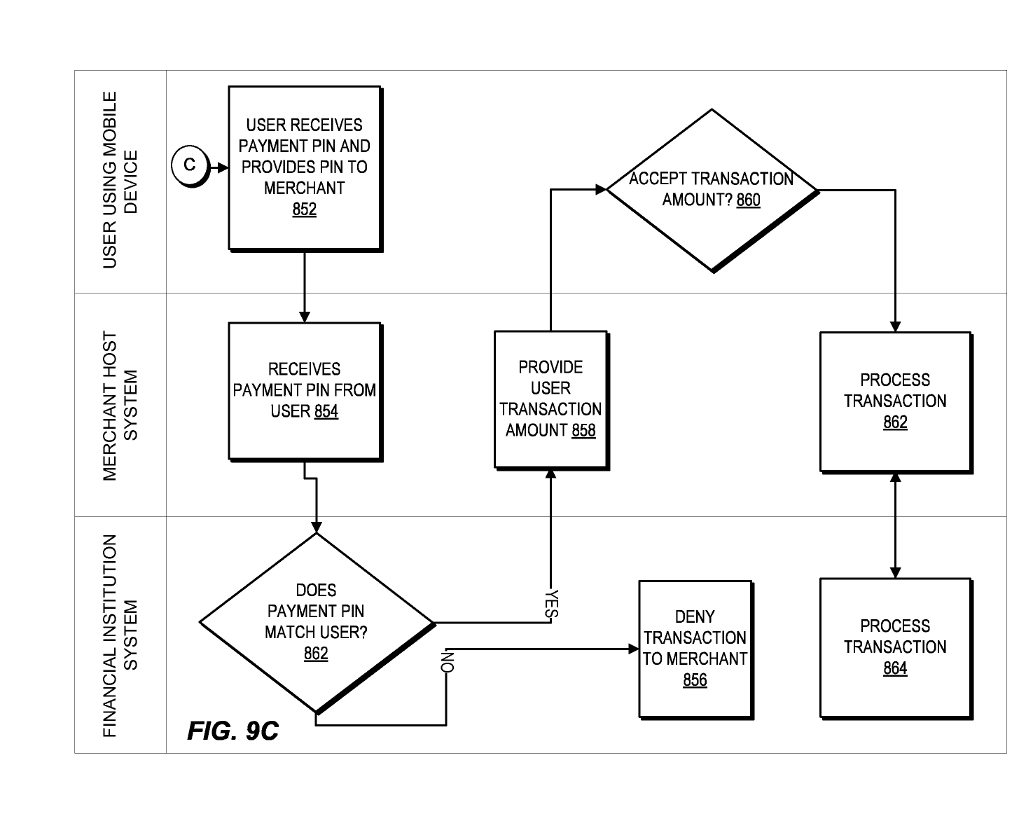

FIGS. 9A-9C provide flow charts illustrating a process 800 for sending P2P payments using the P2P mobile payment system, in accordance with an embodiment of the invention. FIGS. 9A-9C illustrates the flow chart in terms of “swim lanes” associated with entities which may perform the operations in each respective swim lane. The entities illustrated in the exemplary Figures are a financial institution system, a mobile payment client application, a user using a mobile device, and a merchant host system. However, it should be noted that other entities could also be involved and some embodiments of the invention may not be limited to the four entities illustrated in FIGS. 9A-9C. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process begins at block 802 of FIG. 9A where a financial institution system 600 invites a user 310 to participate in a P2P mobile payment program. The financial institution system 600 may recognize that the user 310 is within an acceptable merchant host system area and therefore may provide the offer of making a purchase at the merchant via the P2P mobile payment system. In some embodiments of the invention, the user 310 requests participation from the financial institution system 600. An interface may be provided to the user 310 via his/her mobile device once the user 310 has initiated the P2P mobile payment system. The process then moves to block 804 where the user 310 using his/her mobile device 400 may accept the invitation to make payments via the P2P mobile payment system via an interface downloadable onto the user's mobile device 400.

The process then moves to block 806 of FIG. 9A where the financial institution system 600 presents to the user the terms of the P2P mobile payment feature that will govern the transfer of funds. The terms allow the financial institution system 600 to inform the user 310 of the merits of using the P2P payment service. These merits include, but are not limited to, making person-to-person transfers of money by using a payment PIN, without the need of providing an account number or other personal identifiers. Additionally, information is provided to the user 310 that a fee may be associated with transferring funds. The financial institution system 600 also informs the user 310 that the amount of any fee is disclosed prior to making the P2P transfer. The financial institution system 600 also informs the user 310 that he/she can read more details about this fee in the service agreement that is linked into the P2P payment terms of the payment interface 1100. In some embodiments, a fee may not be associated with using the P2P mobile payment system.

The financial institution system 600 also informs the user 310 that there may be dollar amounts and other limits that apply for these P2P transfers. The financial institution system 600 may informs the user 310 that the user may find in the P2P payment terms an applicable daily cut off times and delivery times for making these P2P transfers. FIG. 10 also illustrates a confirmation or acceptance check box which the user may activate if the user confirms that he/she has read and agrees to the terms of the service agreement. The user 310 accepts the terms of the P2P service by selecting button that confirms that the user 310 meets the requirement discussed in the terms in block 808, and then activating the “accept” button to indicate the first user's willingness to proceed with setting up the P2P mobile payment system via the user's mobile device 400.

The process then moves to block 810 of FIG. 9A where the financial institution system 600 presents the user with a downloadable mobile payment client application for the user's mobile device, so that the user can input all the information required to make the transfer.

The process then moves to block 812. At block 812 the 310 user via his/her mobile device may accept to download the application to his/her mobile device. At this point the user 310 may sign into the P2P mobile application by providing authentication information in block 814. Authentication information may be in many forms, including, but not limited to an access ID, PIN, password, code, etc. Once the user 310 provides the sign in and authentication information, the mobile payment client application receives the authentication information and sends it to the financial institution system for processing in block 816. The financial institution system authenticates the user 310 and communicates that decision back to the mobile payment client application such that the user 310 may now have access to the application in block 818. The mobile payment client application receives the authentication 820 from the financial institution system and provides the user 310 with merchant payment options, in the form of which merchants are available in the user's 310 area and what accounts the available merchants will accept for a transaction from the user 310, in block 825.

As illustrated in FIG. 10, the payment interface 1100 may be received by the user 310 via the user's mobile device. The payment interface 1100 may be associated with the mobile payment client application and provide the user with selections as described. At selection 1102 the user 310 may provide a user access ID to initiate the P2P mobile payment process. Once the system recognizes the location of the user 310 and ensures that the user 310 is located at or near acceptable merchant hosts that offer payment of transactions through the P2P mobile payment system.

Referring now to FIG. 9B, the merchant payment menu option may be provided via the mobile payment client application to the user 310 in block 832. The user 310 using a mobile device may then select an acceptable merchant host system in the area, in block 830. The user 310 may select the merchant via the payment interface 1100 illustrated in FIG. 10. The payment interface 1100 provides the available merchants to make a payment 1106. For example in section 1106 the user 310 has the option of directing payment via the P2P mobile payment system to Merchant 1 in section 1126 or to make a payment to Merchant 2 at section 1128.

At block 836 of FIG. 9B the financial institution system may provide eligible bank accounts and there balances to the client application and subsequently the client application may display the list of accounts in block 838. The user 310 may visualize and select the account to use to transfer funds via the P2P mobile payment system in block 840. As illustrated in the payment interface 1100 of FIG. 10, the payment accounts menu 1104 provides the payment accounts the user 310 or merchant determines available for the merchant purchase. For example, a merchant may not accept certain accounts for a transaction, thus, these accounts may not be available for the transaction via the P2P mobile payment system, for the user 310. The payment accounts menu 1104 may provide a user default payment account 1112, which is the account the user 310 has designated as the default payment for all P2P mobile payments. However, the user 310 may also select from other accounts available to the user 310, such as checking 1 1114, checking 2 1116, credit card 1 1118, credit card 2 1120, and credit card 3 1124.

Once an account is determined and selected by the user 310 using the payment interface 1100, at block 842 of FIG. 9B, the financial institution system determines if sufficient funds exist in the account for the transaction. If sufficient funds are available the mobile payment client application provides the user with a randomly generated payment PIN in block 844. The user 310 may receive the payment PIN at his mobile device in block 852 of FIG. 9C. The user 310 may receive the payment PIN from the financial institution via the payment interface 1100 as illustrated in FIG. 10. At section 1110 the payment PIN is provided to the user 310. In the embodiment illustrated in FIG. 10 the payment PIN is “####” which may correspond to four numbers or letters, as illustrated in section 1140. The payment interface 1100 may also proved an indication as to the amount of the transaction such that the user 310 may confirm the amount and for security purposes, as illustrated in the confirm amount section 1108. In this case, the user 310 is purchasing from Merchant 1 and he/she may confirm the amount by selecting the confirm button 1144. The payment interface 1100 may also provide the user 310 with access to the terms and conditions of making payments via the P2P mobile payment system at selection 1146. Once the user 310 has read the terms he/she may accept the terms at section 1148. Once the terms are accepted the user 310 may proceed with a transaction via the P2P mobile payment system.

Once a payment PIN is received by the user 310 in block 852, the user 310 may input the payment PIN onto a display at the merchant host system. The financial institution may receive the payment PIN from the merchant host system and determine if there is a match between user 310 and the merchant sending the payment PIN, in block 862. If no match is determined the transaction is denied by the financial institution in block 856. In block 858, if a match is determined, the user may accept the transaction amount in block 860, based on the transaction amount provided by the merchant host system, in block 858. Once the user 310 has accepted the transaction amount in block 860 the transaction may be processed. In some embodiments, the transaction may be processed by the merchant host system, as illustrated in block 862. In some embodiments, the transaction may be processed by the financial institution system, as illustrated in block 864.

In some embodiments, a merchant host system 500 may recognize a user 310 mobile device 400 within the area of the merchant host system 500 and trigger the activation of the user's 310 mobile payment client application. It is noted that this procedure is not required in all contemplated embodiments of the present invention. In one or embodiments, the user 310 may initiate the mobile payment client application without being recognized and prompted to do so. In these embodiments, when the user 310 decides to make a purchase, the user 310 could open the mobile payment client application and determine whether the merchant is a member of the program. The user 310 could then initiate the payment process as described above on his/her own initiative.

The above disclosure describes a payment process. It noted that payment is used in a general matter to describe any type of transaction involving transfer of funds, points, etc. from one user to another. For example, the payment could be a contribution, money transfer, transfer of loyalty points, transfer of a debt, or any other type of transfer of funds, points, debt, etc. between two parties.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for providing payment to a merchant, the method comprising:
receiving, via a computer device processor, an indication that a user wants to participate in a transaction with a merchant via non-near field communications;
providing the user with payment accounts associated with the user, wherein the payment accounts associated with the user are payment accounts that the merchant accepts as for payment of the transaction;
receiving an indication of a selected payment account, wherein the selected payment account is one of the provided payment accounts associated with the user, wherein the user selects the selected payment account from the provided payment accounts associated with the user;
providing, via a computer device processor, the user with a randomly generated identification number associated with the selected payment account selected, wherein the randomly generated identification number acts as an account number for the selected payment account for the transaction;
receiving an indication that wherein the user has provided provides the randomly generated identification number as payment associated with the selected payment account to the merchant to complete the transaction, wherein the randomly generated identification number is recognized by the merchant as being associated with the selected payment account and an account number associated with the selected payment account; and
allowing for processing of the transaction using the randomly generated identification number associated with the selected payment account, such that a financial institution and the merchant processing the transaction associates the randomly generated identification number with the account number associated with the selected payment account to complete the transaction, wherein processing of the transaction using the randomly generated identification number allows for transferring of a payment amount from the selected payment account to an account associated with the merchant to complete the transaction, wherein the payment amount is based at least in part on the transaction.

2. (canceled)

3. The method of claim 1 further comprising determining that the merchant is an acceptable merchant to accept the randomly generated identification number at the merchant's point of sale to complete the transaction.

4. The method of claim 3, wherein determining that the merchant is an acceptable merchant for accepting the randomly generated identification number at the merchant's point of sale to complete the transaction further comprises determining a location of the user within the acceptable merchant.

5. The method of claim 4, wherein determining the location of the user within the acceptable merchant is established through non-near field communications.

6. The method of claim 1 further comprising allowing the the randomly generated identification number associated with the selected payment account to become a static identification number associated with the selected payment account, wherein the static identification number is associated with the selected payment account for a period of time after the transaction such that the user provides the static identification number to the merchant to complete the transaction.

7. (canceled)

8. The method of claim 1 further comprising the transferring of the payment from the account associated with the user to the an account associated with the merchant is based at least in part on the merchant responding to a payment notification indicating authorization to receive payment.

9. The method of claim 1, wherein the randomly generated identification number associated with the account selected is unique, such that the randomly generated identification number corresponds to the account selected and is acceptable for payment for a limited amount of time.

10. A computer program product for providing payments to a merchant, the computer program product comprising a non-transitory computer-readable medium storing computer-executable instructions to perform:
receiving an indication that a user wants to paritcipate in a transaction with a merchant via non-near field communications;
providing the user with payment accounts associated with the user, wherein the payment accounts associated with the user are payment accounts that the merchant accepts as for payment of the transaction;
receiving an indication of a selected payment account, wherein the selected payment account is one of the provided payment accounts associated with the user, wherein the user selects the selected payment account from the provided payment accounts associated with the user;
providing, via a computer device processor, the user with a randomly generated identification number associated with the selected payment account selected, wherein the randomly generated identification number acts as an account number for the selected payment account for the transaction;
receiving an indication that wherein the user has provided the randomly generated identification number as payment associated with the selected payment account to the merchant to complete the transaction, wherein the randomly generated identification number is recognized by the merchant as being associated with the selected payment account and an account number associated with the selected payment account; and
allowing for processing of the transaction using the randomly generated identification number associated with the selected payment account, such that a financial institution and the merchant processing the transaction associates the randomly generated identification number with the account number associated with the selected payment account to complete the transaction, wherein processing of the transaction using the randomly generated identification number allows for transferring of a payment amount from the selected payment aft account associated with the user to an account associated with the merchant payment receiver to complete the transaction, wherein the payment amount is based at least in part on the transaction.

11. (canceled)

12. The computer program product of claim 10 further comprising computer-executable instructions to perform determining that the merchant is an acceptable merchant to accept the randomly generated identification number at the merchant's point of sale to complete the transaction.

13. The computer program product of claim 10, wherein determining that the merchant is an acceptable merchant for accepting the randomly generated identification number at the merchant's point of sale to complete the transaction further comprises determining a location of the user within the acceptable merchant.

14. The computer program product of claim 13, wherein determining the location of the user within the acceptable merchant is established through non-near field communications.

15. The computer program product of claim 13 further comprising computer-executable instructions to perform allowing the the randomly generated identification number associated with the selected payment account to become a static identification number associated with the selected payment account, wherein the static identification number is associated with the selected payment account for a period of time after the transaction such that the user provides the static identification number to the merchant to complete the transaction.

16. (canceled)

17. The computer program product of claim 13 further comprising the transferring of the payment from an account associated with the user to the account associated with the merchant is based at least in part on the merchant responding to a payment notification indicating authorization to receive payment.

18. The computer program product of claim 13, wherein the randomly generated identification number associated with the account selected is unique, such that the randomly generated identification number corresponds to the account selected and is acceptable for payment for a limited amount of time.

19. A system for providing payments to a merchant, the system comprising:
a computer apparatus including a processor and a memory; and
an online payment module stored in the memory, executable by the processor and configured to:
receive an indication that a user wants to participate in a transaction with a merchant via non-near field communications;
provide the user with payment accounts associated with the user, wherein the payment accounts associated with the user are payment accounts that the merchant accepts as for payment of the transaction;
receive an indication of a selected payment account, wherein the selected payment account is one of the provided payment accounts associated with the user, wherein the user selects the selected payment account from the provided payment accounts associated with the user;
provide the user with a randomly generated identification number associated with the selected payment account, wherein the randomly generated identification number acts as an account number for the selected payment account for the transaction;
receiving an indication that the user has provided the randomly generated identification number associated with the selected payment account to the merchant to complete the transaction, wherein the randomly generated identification number is recognized by the merchant as being associated with the selected payment account and an account number associated with the selected payment account; and
allow for processing of the transaction using the randomly generated identification number associated with the selected payment account, such that a financial institution and the merchant processing the transaction associates the randomly generated identification number with the account number associated with the selected payment account to complete the transaction, wherein processing of the transaction using the randomly generated identification number allows for transferring of a payment amount from the selected payment account to an account associated with the merchant to complete the transaction, wherein the payment amount is based at least in part on the transaction.

20. (canceled)

21. The system of claim 19, wherein the online payment module is further configured to determine that the merchant is an acceptable merchant to accept the randomly generated identification number at the merchant's point of sale to complete the transaction.

22. The system of claim 21, wherein determining that the merchant is an acceptable merchant for accepting allowing a payment via the randomly generated identification number at the merchant's point of sale to complete the transaction further comprises determining a location of the user within the acceptable merchant.

23. The system of claim 22, wherein determining the location of the user within the acceptable merchant is established through non-near field communications.

24. The system of claim 19, wherein the online payment module is further configured to allow the providing the user a randomly generated identification number associated with the selected payment account to become a static identification number associated with the account selected payment account, wherein the static identification number is associated with the selected payment account for a period of time after the transaction such that the user provides the static identification number to the merchant to complete the transaction as payment.

25. (canceled)

26. The system of claim 19, wherein the online payment module is further configured to transfer of the payment from the aft account associated with the user to the an account associated with the merchant is based at least in part on the merchant responding to a payment notification indicating authorization to receive payment.

27. The system of claim 19, wherein the randomly generated identification number associated with the account selected is unique, such that the randomly generated identification number corresponds to the account selected and is acceptable for payment for a limited amount of time.

28. The method of claim 1 further comprising erasing the randomly generated identification number upon completion of processing of the transaction, such that the randomly generated identification number is no longer associated with the selected payment account.

29. The computer program product of claim 10 further comprising computer-executable instructions to perform erasing the randomly generated identification number upon completion of processing of the transaction, such that the randomly generated identification number is no longer associated with the selected payment account.

30. The system of claim 19, wherein the online payment module is further configured to erase the randomly generated identification number upon completion of processing of the transaction, such that the randomly generated identification number is no longer associated with the selected payment account.
